(19) United States
(12) Patent Application Publication
(10) Pub. No.: US 2014/0316949 A1
(43) Pub. Date: Oct. 23, 2014

(54) BUYER-SELLER PROPERTY MATCH MAILER NOTIFICATION METHOD

(71) Applicant: Bryan K. Copley, Auburn, WA (US)

(72) Inventor: Bryan K. Copley, Auburn, WA (US)

(21) Appl. No.: 14/280,505

(22) Filed: May 16, 2014

Related U.S. Application Data
(60) Provisional application No. 61/813,858, filed on Apr. 19, 2013.

(51) Int. Cl. G06Q 30/06; G06Q 50/16

(52) U.S. Cl. CPC G06Q 30/0627; G06Q 50/16
USPC 705/26.63

(57) ABSTRACT

The invention disclosed herein is a method for informing uncommitted potential property owners that a buyer is potentially interested in purchasing a property with similar features as those possessed by the owner's property. The inventive method matches buyers interested in purchasing a property, such as a home, with prospective sellers that may be interested in selling their respective properties, via a web-based service maintained through a service provider. The sellers are prospective sellers and are made aware of buyer interest in their property by a service provider website, which instigates finding their properties through a title search, wherein search criteria are given to the title search based on buyers' property search criteria. Returned matches are listed, and from the information provided by the title search, a match mailer is sent to the property owner informing the owner of a buyer that may be interested in purchasing the property. If owner is interested, they may initiate contact with the potential buyer via the service provider's website.

### CROSS-REFERENCE TO RELATED APPLICATIONS

This utility application claims the benefit of U.S. Provisional Application No. 61/813,858, filed Apr. 19, 2013.

### FIELD OF THE INVENTION

This invention relates to facilitation of web-based buyer-seller matching methods.

### BACKGROUND

A very real problem in the real estate industry is the inability to produce inventory for buyers at times in the market wherein potential sellers, for any variety of reasons, deem selling his or her home undesirable. The current real estate market resembles such a time. Reports of multiple offers on homes for sale are rampant, but real estate agents and the industry overall loudly lament that there are not more options, not enough inventory, for their qualified buyers to select from.

One of the causes of this issue is that sellers don't desire to list their home for sale just to find out if there is a buyer for their home. The current process of listing a home for sale is costly, not only in the sense of the time investment by a seller and/or their agent, but the financial investment for both, the tedious process of waiting for a buyer by both parties, and the fact that having to arrange a home in a certain manner and evacuate a home during open houses or impromptu showings can be overall, a life-interrupting process. The potential payoff can be outstanding, and the process will be necessary for most an average of three times during their lives, but the risk of enduring this headache only to find out that there is not a buyer for their property, for many, is often not worth the potential of selling their home. Thus, they do not list their property for sale, although they may actually have interest in selling.

This creates another problem: buyers and their agents who cannot locate the precise home an exacting and approved buyer is looking to purchase. Demand is not met with supply, precisely because supply is not aware of demand. The market is opaque, and buyers do not have a tool to market themselves.

### SUMMARY

In light of this paradox, the applicant has conceived of a notification method wherein buyers and their agents can take a proactive stance to connect with homeowners whose homes could match their buyer profile on a buyer-seller match service provider's (henceforth referred to as service provider) internet website.

This inventive method comprises steps to allow potential buyers and their agents to proactively originate potential real estate transactions on an internet website via an automated process mediated by software that a) involves utilizing a unique buyer database; b) to partner with and send buyer queries to data providers to generate potential matches, c) which may be sent via mail and tracked.

The notification, henceforth referred to as a ‘match mailer’, is a web-generated document sent via post mail to a homeowner which makes him or her aware of the web service-registered buyer that has interest in a property resembling that of the homeowner. The process comes together as follows:

A potential buyer, or real estate agent acting on behalf of a potential buyer, registers with the service provider and indicates exactly what type of property the buyer is interested in buying. After registration, the service provider may contact the potential buyer or real estate agent acting on behalf of a potential buyer to inform him or her of match mailer notification service to homeowners of properties that potentially match the buyer in question. Buyers and their agents may also proactively contact the service provider about the match mailer notification service via a page on the service provider's website.

If the potential buyer has interest in using the service, the provider may be alerted to this fact by notification from the potential buyer. This may be done by electronic mail or on the website of the provider, for instance by entering data in specific data fields or clicking on a button. The web-service provider may then request data from a third party, who may be, by way of example, a title or escrow company, or directly from county tax records. The requested data to be returned to the web-service provider may then be compiled into a list of properties that most closely match the specifications provided by the potential buyer that have been entered into the database of the web-service provider as property search criteria.

The data may then be provided back to the web-service provider in the form of a list of matches that substantially match the buyer search criteria query. The number of matches may be then indicated to the buyer, who then decides how many notifications he or she would like to be sent out as notifications to the individual owners of a number of matching properties appearing on the list. This number may range from one to the total number of matching properties on the list, and is determined at the discretion of the buyer. The web-service provider is then notified of the number by electronic means through the provider's website, said electronic means may be, for example, electronic mail or by entry of the buyer-chosen number by the buyer on a specific webpage or portion thereof that is dedicated to the match mailer order, whereby the webpage is on the service provider's website.

A match mailer order is then generated by the web-service provider for a specific number of property matches and may be sent to the third party, such as the title company that provided the original list of matches. The third party service may then sort and complete a list of the best matching properties not to exceed the number indicated in the order made by the potential buyer. The third party service may perform the sorting and completion of a list of best matches using, as, by way of example, a match-ranking algorithm as disclosed in co-pending U.S. Nonprovisional application Ser. No. 14/224,033 to Applicant, incorporated herein in its entirety.

An example of the steps carried out by said match-ranking algorithm is given below in the Detailed Description section. The match-ranking algorithm may be embodied in software that is stored in digital memory on one or more servers linked to the web-service provider or on computers or servers linked to the third party service, and executed by a microprocessor linked to said digital memory. The third party service may also use another proprietary or open-source matching algorithm contained in a software package to compile the list.

The third party service may prepare a spreadsheet or other data file of the matched properties and send the file to the web-service provider, who in turn adds a distinguishing code to each individual property so as to allow for tracking of matches. This spreadsheet or data file containing a list of matched properties, along with their corresponding tracking numbers, may then be sent to the buyer, preferably by electronic means such as electronic mail, for review by the buyer. The buyer may select one or more of the most desirable properties according to the buyer from the list, and communicate these choices to the web-service provider. Preferably, the list of matched properties is ranked in order of properties having attributes that have the most matches to the buyer's search criteria. The buyer may choose to select all of the matched properties.

The web-service provider may in turn order the printing of match mailer letters addressed to the owners of the buyer-selected properties. A portion of the web software linked to the web-service provider's website may execute the printing of the match mailer by an internal printing device connected to a server linked to the website of the web-service provider. Alternatively, the printing of the match mailer may be controlled by a third party. The printing device then generates a match mailer in the form of a printed letter, which may be a form letter, addressed to one or more of the individual property owners whose properties are matched to the buyer's search criteria.

The tracking code generated by the web-service provider's software appears on each mailer, and allows the owner of a matched property to respond to the match mailer if said property owner so chooses, with a tag to a specific buyer in the form of the tracking code, while guarding the anonymity of said buyer. The owners of the matched properties may then be mailed match mailer notifications.

When the individual owners of the matched properties on the matching list receive the written notifications in the form of the match mailer that a potential buyer is interested in a home resembling theirs, the owner is then solicited by wording in the match mailer inviting the owner to log on to the web-service provider's website and to self-register for the buyer-contacting service as a potential seller. This service, according to the invention, is provided by the web-service provider to give a conduit to the owner of a matched property for contacting a potential buyer of service provider's website, they may create a seller profile that is entered into a seller database, and may then enter the tracking code that is indicated on the match mailer.

At this point, if the buyer indicates interest, the buyer's information (email, and whichever other information they would like to pass along) becomes visible to the seller, and the potential buyer and seller can communicate as they see fit to determine if there is mutual interest in pursuing a transaction.

### BRIEF DESCRIPTION OF THE DRAWINGS

FIG. 1. A flowchart representing the inventive method, showing the sequence of steps for generation of a match mailer notification to property owners.

FIG. 2. An example buyer input web interface for entering buyer property preference data.

FIG. 3. Example flowchart of the match-ranking algorithm.

### DETAILED DESCRIPTION

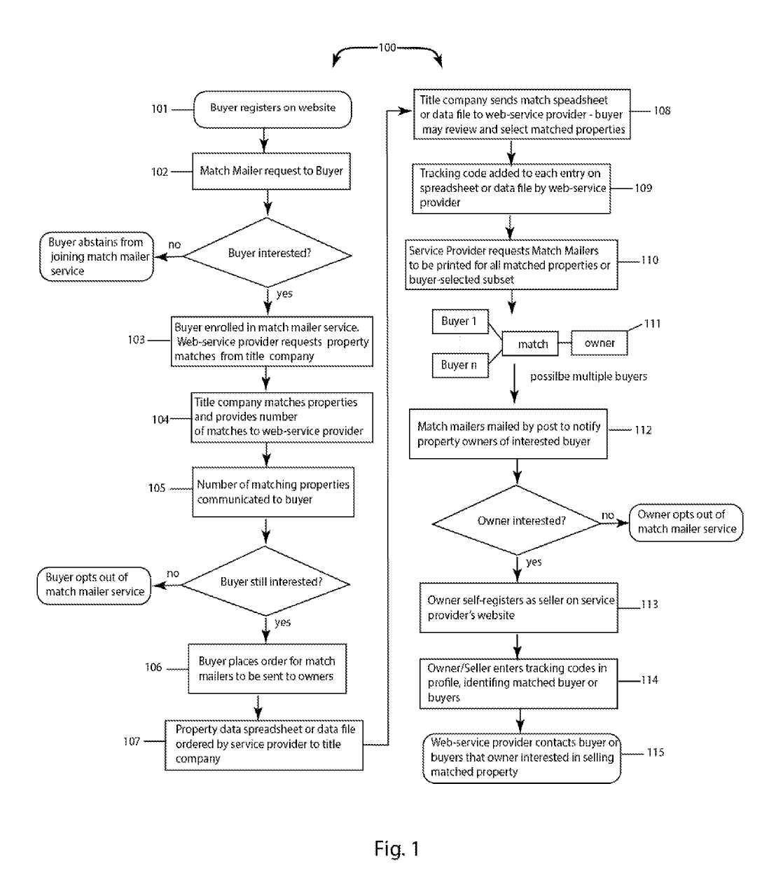

A preferred embodiment of the inventive method is shown in the flowchart 100 of FIG. 1, the details of which are disclosed in the following description. The description is intended to provide a working example of the invention, and by no means is intended to limit the scope of the invention.

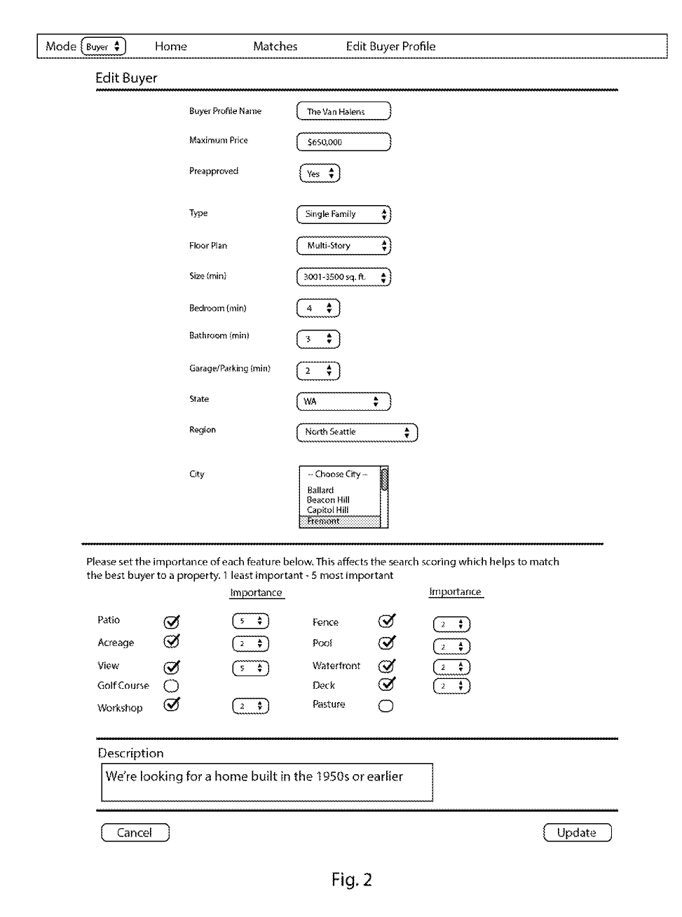

Referring to FIG. 1, a buyer subscribes to the matching service by registering on the provider's website in step 101. The website automatically generates via software a query to the registered buyer if buyer desires to participate in the inventive match mailer service to solicit un-registered owners of properties chosen from title records that are closely matched to the buyers search criteria using a computer-executed matching algorithm (step 102), of which an example is described below. If the buyer is interested in enrolling in the inventive match mailer service, the buyer may communicate the desire to enroll in the service to the web-service provider by electronic means, such as electronic mail or data entry directly on the web-service provider's website via a webpage, having fields for text entry on the part of the buyer, or by provision of a virtual button upon which the buyer may click, or by checking a box or a radio button. An example of a buyer input interface page is shown in FIG. 2.

Having received the buyer request to enroll in the match mailer service through the website as described, the web-service provider may then send a first inquiry to a title company or other third party service with which the web-service provider may have a relationship, for example, with which the web-service provider may have contracted to search title databases to find matching properties matching the buyer's specifications (step 103).

Using matching algorithms embodied in computer-executable software, either proprietary or open-source, the title company or other third party service returns the number of matches found by the matching algorithm to the web-service provider (104). The number of matches found by the title company or third party service may be communicated to the web-service provider preferably by a web interface on the website of the web-service provider to directly input the data to a database where it is automatically recorded, or by other means such as electronic mail for manual input of the number of matches found. Alternatively, the web software of the web-service provider may automatically access title company or third party service title records and perform the match directly using, for instance, a matching algorithm disclosed in co-pending U.S. Nonprovisional patent application Ser. No. 14/224,033 to Applicant, incorporated herein in its entirety.

The web-service provider may inform the buyer of the number of matches found that correspond to the buyer's search criteria, preferably by electronic means, such as an automated electronic mail notification issued by the web software hosted on one or more servers linked to the web-service provider (step 105). At this point the buyer is solicited to enroll in the inventive match mailer service. The buyer makes a decision whether or not to enroll, and if the buyer decides to enroll in the match mailer service and go forward with the match mailer contacting service, the buyer may place an order with the web-service provider requesting that match mailers be generated and sent to the respective property owners (step 106). The buyer may then notify the web-service provider of his or her desire to enroll in the match mailer service, whereby the buyer may use an electronic means to notify the web-service provider, such as, but not limited to: electronic mail, or by entry of data into a webpage associated with the web-service provider's website, checking a virtual box or radio button, or clicking on a virtual button.

At this juncture, the web-service provider may send a second request to the title company or third party service that had initially supplied the matched property count, for a detailed data file or spreadsheet that contains a list of property matches determined by a match ranking algorithm, described below, preferably in order of the ranking determined by the match ranking algorithm (step 107). The spreadsheet or data file may be returned to the web-service provider, as shown in step 108 of FIG. 1. The spreadsheet or data file also contains the contact details for the owners for each of the matched properties. In step 109, the service provider adds a tracking code to each of the listed properties.

The buyer may first request to review the list of matched properties before match mailers are sent to all of the owners of the matched properties, as shown in step 108. In this case, the buyer may select a subset of properties from the totality of the algorithm-matched properties. The web-service provider may then request the printing of match mailers, which may be generated as form letters, corresponding to the selected properties (step 110) by either a third party print service or internally by a printer device connected to a server on which the website software resides, whereby the software can access the data file or spreadsheet.

It may also be possible to have multiple buyers being presented with the same properties on a match list who have entered similar property search criteria. Moreover, multiple buyers may select one or more of the same properties for a match mailer contact, as shown in step 111.

The match mailers may then by sent by postal mail to the individual property owners identified by the title company or third party service, and selected by the buyer, to notify said owners of the selected matched properties that the buyer is potentially interested in purchasing a property similar to that of the owner (step 112). Postal mail means is chosen to make contact with the owners of the matched properties as the postal address is contained in the property data, and other contacting coordinates for the owners, such as telephone numbers or electronic mail addresses are typically not available.

The match mailer also contains the tracking code corresponding to the property match. If one or more of the individual property owners are interested in contacting the buyer, the interested owners may self-register on the web-service as sellers, setting up a seller's profile on the service provider's website (step 113). During this process, the registered property owner (now a seller) may enter the tracking code provided by the received match mailer to identify the interested buyer or multiple buyers to the web software, in which the tracking code may be recorded in a separate database. The website software tracks the information, and reports the fact that an owner of a matched property desires to contact the interested buyer (or multiple buyers). In addition, the software may maintain statistics on the number of sellers and their identity that respond to the match mailers.

FIG. 2 shows an example of the web interface for a buyer to input property attribute search data that are stored in a buyer database on one or more servers linked to the web-service provider's website. The property descriptive data may be stored in a separate database maintained by the title company or third party service, or by the web-service provider. A matching algorithm may be employed to compare the stored property descriptive data to the buyer's search data. The example buyer input webpage may have drop-down menus allowing the buyer to enter property search criteria for a home, as shown in the top portion of the webpage in FIG. 2. On the bottom portion of the webpage of FIG. 2, the buyer may select specific property attributes and assign an importance score to each selected attribute. The importance scores may be used to rank the matches discovered by a matching algorithm. An example of such a ranking algorithm is described in detail in U.S. Nonprovisional patent application Ser. No. 14/224,033 to Applicant, incorporated herein in its entirety. A brief description of the generation of a ranked match list is described in the following section.

### Example of Ranked-Matching Algorithm

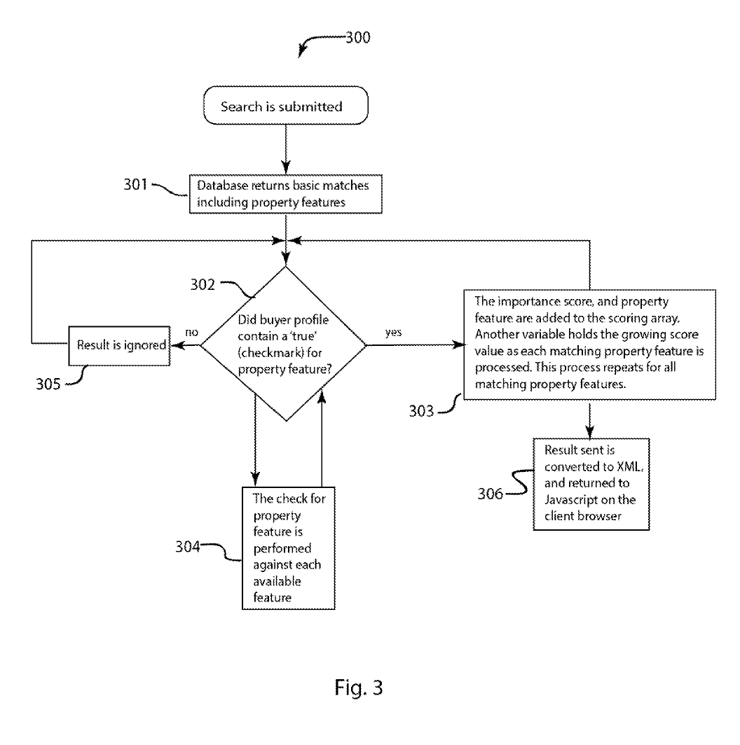

The algorithm first matches price points indicated by price field data entered by the buyer upon registration. A basic flow chart for the algorithm is shown in FIG. 3. The buyer may have entered data on the example web interface page as shown in FIG. 2, as described above. As an example, the buyer may make a selection from a drop-down menu from the top half of the example webpage shown in FIG. 2, presenting price ranges the buyer may be willing to pay for a property. Price ranges may be presented in increments of $50,000 from a dropdown menu, wherein a price range of $300,001-$350,000 is chosen as a first-tier match criterion. The matching algorithm finds all properties in the third-party service database matching this first criterion, and may then create a temporary database representing a first cohort of these properties that match this first criterion, the first cohort being a subset of all properties in the third party's property database.

As a second step, the algorithm may search among the properties in the first cohort for matches based on living space. For living area size of a single family dwelling, the buyer may have entered a value of 2500 square feet. All registered buyers are prompted to enter values for a desired size range of a single family dwelling into the living area field upon registration. The matching routine may then find the properties within the first cohort that have a range of living space size encompassing 2500 square feet. By way of example, a series of size (area) ranges in increments of 500 square feet are presented to the buyer in a drop-down menu. Those properties in the first cohort that have 2001-2500 square feet of living space are found are then may be organized into a second cohort of buyers.

The next criterion on the list is then searched amongst these properties. For example, the minimum number of bedrooms, bathrooms and garage space entered by the buyer are compared to the properties of the second cohort. If the buyer search criteria includes a desire for two-bedroom home, this is matched to all properties included in the second cohort that have at least two bedrooms, and eliminates those with three bedrooms or more or only one bedroom.

The matching process continues according to the afore-mentioned algorithm until all the entry fields have been exhausted, and culls properties not matching the criteria, creating new cohorts as each field is matched, wherein the number of buyers in the successive cohorts may shrink as properties are culled. A final property cohort is created after the last field is processed, whereby the final property cohort represents a list of raw matches. The raw matching process is embodied by the algorithm in step 301 of flowchart 300 displayed in FIG. 3, where the details of the aforementioned portion of the matching process have been omitted.

After returning the basic matches that include the basic property fields, the ranking algorithm (flowchart 300 in FIG. 3) will next refine the matches by executing a scoring function, whereby the property attributes, or features, to which the buyer has assigned an importance score value as part of the buyer search criteria, are compared and matched, as indicated in decision branch step 302 of FIG. 3; if a match occurs, the numerical importance score value for that feature is captured and stored in a scoring array (step 303).

The score is also added to a running sum variable that grows as each matching property feature is processed by the algorithm. The scoring function of the ranking algorithm repeats steps 302-305 until the feature list is exhausted, where the running sum variable now holds the sum result of the importance scores. Accordingly, the inventive algorithm then converts the result, which can be considered an overall importance score, to XML, or another format to compile a list of ranked matches which may be then returned to the web-service provider's website, as indicated in step 306.

At this juncture, the buyer can select the preferred properties based on the refined ranking performed by the matching algorithm.

The embodiments of the invention described above are meant to be exemplary only, and by no means are intended to restrict or limit the inventive method to the literal descriptions. It will be appreciated by those skilled in the art that other variations are possible without departing from the scope and spirit of the invention as disclosed.

1. An internet-based buyer-seller interaction method, comprising the steps of:
(i) self-registering by a buyer on a website provided by a web-service provider;
(ii) providing an input means for inputting search criteria by said buyer, whereby said buyer inputs data in data entry fields presented to said buyer on the web-service provider's buyer profile webpage, said input data subsequently stored in a database hosted on a server linked to the web-service provider;
(iii) entering search criteria data by said buyer in the data entry fields presented to said buyer on the web-service provider's buyer profile webpage;
(iv) storing said search criteria data in a database hosted on a server linked to the web-service provider;
(v) automatically contacting the buyer with software-generated automated request by electronic means to invite said buyer to subscribe to an automated buyer-seller matching service of the web-service provider whereby the buyer's entered search criteria data are bundled and sent to a buyer-seller matching algorithm executed by software instructions to a microprocessor, said matching algorithm adapted to match the buyer's search criteria data with descriptive property data derived from one or more third-party databases;
(vi) enrolling said buyer to participate in said buyer-seller matching service whereby the buyer enters affirmative response to said request on a webpage of the web-service provider website;
(vii) matching said buyer's property search criteria data with property descriptive data contained in the one or more third-party databases, whereby said buyer-seller matching algorithm mines property-descriptive data from the one or more third-party databases, and matching the data to the buyer's property search data, the matching algorithm being embodied in micro-processor executable software hosted by one or more servers linked the web-service provider;
(viii) generating a list of property matches determined by said buyer-seller matching algorithm, whereby the matches correspond to properties most resembling the buyer's property search criteria, said list being generated automatically by software hosted on one or more servers linked to the third party databases and sent to the web-service provider by automatically-generated communication means;
(ix) sending the number of matches to the buyer by the web-service provider;
(x) requesting that the owners of said listed properties be notified by web-service provider by the subscribed buyer, whereby the subscribed buyer sends a request to the web-service provider by entering said request on a webpage of the web-service provider's website; and
(xi) generating match mailer notifications by service provider to be mailed to the postal addresses of said owners of said listed properties, whereby the notifications are automatically generated from software hosted on the one or more servers linked to the web-service provider.

2. The method of claim 1, further comprising the steps of:
(i) self-registering by the one or more contacted owners of said listed properties on the website of said web-service providers by said one or more owners interested in contacting the buyer matched to the properties of said one or more contacted owners; and
(ii) initiating contact with said buyer by the one or more contacted owners of said matched properties.

3. The method of claim 1, wherein the step automatically contacting the buyer with software-generated automated request by electronic means is carried out such that the electronic means is electronic mail.
